(19) United States
(12) Patent Application Publication
(10) Pub. No.: US 2025/0329860 A1
(43) Pub. Date: Oct. 23, 2025

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Osaka (JP); Osamu NAKAYAMA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/855,197

(22) PCT Filed: Apr. 12, 2023
(86) PCT No.: PCT/JP2023/014877

§ 371 Date: Jul. 8, 2025

(30) Foreign Application Priority Data
Apr. 26, 2022 (JP) 2022-072268

(51) Int. Cl. H01M 50/298; H01M 50/249; H01M 50/507; H01M 50/519

(52) U.S. Cl. CPC H01M 50/298; H01M 50/249; H01M 50/507; H01M 50/519; H01M 2200/103

(57) ABSTRACT

A wiring module 20 to be attached to a plurality of power storage devices 11 includes a wire, a terminal 60 connected to the wire, and a circuit board 30, with the terminal 60 including a connecting part 63 connected to the circuit board 30, the circuit board 30 including a connection land to which the connecting part 63 is soldered, the connecting part 63 having a cut part 71 formed by cutting a metal plate material, and a pair of connecting surfaces 70 arranged so as to be positioned front and back of each other and connected via the cut part 71, and at least one of the pair of connecting surfaces 70 intersecting the surface of the connection land and being arranged continuously therewith.

### TECHNICAL FIELD

The present disclosure relates to a wiring module.

### BACKGROUND ART

High-voltage battery packs used in electric vehicles, hybrid vehicles, and the like typically have a large number of stacked battery cells that are electrically connected in series or parallel by a wiring module. Such a wiring module can be configured to include busbars connected to electrode terminals of the battery cells, a printed circuit board and electrical wires. For example, the wiring module may be provided with a connection structure between the wires and the printed circuit board described in JP 2009-76224A (Patent Document 1 below).

The connection structure between the wires and the printed circuit board according to Patent Document 1 includes terminal fittings connecting the wires and the printed circuit board. The terminal fittings are formed by subjecting a conductive metal plate to processing such as punching or bending. The terminal fittings include a wire connecting part that is connected to the wires and a board joining part that is joined to the printed circuit board. In the configuration of Patent Document 1, the board joining part and the printed circuit board are joined, by melting a joining material such as cream solder interposed between the bottom surface of the board joining part and the surface of the printed circuit board in a reflow oven.

### CITATION LIST

### Patent Documents

Patent Document 1: JP 2009-76224A

### SUMMARY OF INVENTION

### Technical Problem

In the above configuration, the board joining part and the printed circuit board are joined by reflow soldering, but the board joining part and the printed circuit board can also be soldered by melting thread solder with a soldering iron or laser irradiation around the board joining part placed on the printed circuit board. Specifically, the board joining part and the printed circuit board can be connected, as a result of the melted solder wetting and spreading on the conductor pattern of the printed circuit board and the side faces of the board joining part arranged continuously with the conductor pattern.

Incidentally, cut parts that are formed by punching a metal plate have an uneven shape and high surface tension, and are thus difficult to wet with solder. In the above configuration, the side faces of the board joining part arranged continuously with the printed circuit board are cut parts of a metal plate, and wetting and spreading the solder is difficult. Accordingly, in the above configuration, it can take time to solder the board joining part and the printed circuit board using a soldering iron or laser irradiation.

### Solution to Problem

A wiring module of the present disclosure is a wiring module to be attached to a plurality of power storage devices, including a wire, a terminal connected to the wire, and a circuit board, with the terminal including a connecting part connected to the circuit board, the circuit board including a connection land to which the connecting part is soldered, the connecting part having a cut part formed by cutting a metal plate material, and a pair of connecting surfaces arranged so as to be positioned front and back of each other and connected via the cut part, and at least one of the pair of connecting surfaces intersecting a surface of the connection land and being arranged continuously therewith.

### Advantageous Effects of Invention

According to the present disclosure, a technology for facilitating soldering of a terminal and a circuit board in a wiring module can be provided.

### BRIEF DESCRIPTION OF DRAWINGS

FIG. 1 is a schematic view showing a vehicle equipped with a power storage module according to a first embodiment.

FIG. 2 is a plan view of the power storage module.

FIG. 3 is a partially enlarged plan view of the power storage module showing the periphery of a circuit board.

FIG. 4 is a perspective view of the power storage module showing the periphery of the circuit board.

FIG. 5 is a plan view of the circuit board.

FIG. 6 is a schematic sectional view taken along line A-A in FIG. 5.

FIG. 7 is a perspective view of a terminal.

FIG. 8 is a partially enlarged plan view of the power storage module showing the periphery of a connecting part of the terminal.

FIG. 9 is a schematic cross-sectional view taken along line B-B in FIG. 8.

FIG. 10 is a perspective view showing a connecting portion between the terminal and the circuit board.

FIG. 11 is a perspective view showing a connecting portion between a terminal and a circuit board according to a comparative example.

FIG. 12 is a partially enlarged plan view of a power storage module showing the periphery of a connecting part of a terminal according to a second embodiment.

FIG. 13 is a perspective view of the power storage module showing the periphery of the connecting part of the terminal.

FIG. 14 is a perspective view of a terminal according to a third embodiment.

### DESCRIPTION OF EMBODIMENTS OF DISCLOSURE

Initially modes of the present disclosure will be enumerated and described.

(1) A wiring module of the present disclosure is a wiring module to be attached to a plurality of power storage devices, including a wire, a terminal connected to the wire, and a circuit board, with the terminal including a connecting part connected to the circuit board, the circuit board including a connection land to which the connecting part is soldered, the connecting part having a cut part formed by cutting a metal plate material, and a pair of connecting surfaces arranged so as to be positioned front and back of each other and connected via the cut part, and at least one of the pair of connecting surfaces intersecting a surface of the connection land and being arranged continuously therewith.

The terminal is formed by punching, bending, or the like of a metal plate. At this time, the connecting part includes a cut part formed by punching and a connecting surface that is an outer surface of the original metal plate material. Generally, the surface tension of the cut part is high compared to the connecting surface, since the surface roughness is large. Accordingly, the cut part has poorer wettability of the solder than the connecting surface.

According to the above configuration, the connection land is arranged continuously with the connecting surface of the connecting part, and thus it is easy to solder the connection land and the connecting part, as a result of the solder wetting and spreading from the connection land to the connecting surface.

Preferably, the connecting part includes a plating layer, and a surface of the plating layer constitutes at least part of the pair of connecting surfaces.

According to such a configuration, by using a metal that has superior solder wettability to the metal constituting the inside of the terminal as a plating layer, soldering of the connection land and the connecting part becomes easier to perform.

(3) Preferably, the surface of the connection land opposes part of the cut part, and both of the pair of connecting surfaces are arranged continuously with the surface of the connection land.

According to such a configuration, both of the pair of connecting surfaces are continuous with the surface of the connection land, and thus soldering of the connection land and the connecting part becomes even easier to perform.

(4) Preferably, the connecting part has a tapered part including a distal end portion of the terminal in an extension direction of the terminal, and the tapered part has a tapered shape formed by the pair of connecting surfaces approaching each other proceeding toward the distal end portion side in the extension direction.

According to such a configuration, the connecting part is provided with a tapered part that includes the distal end portion of the terminal, thus enabling the area of the cut part arranged on the distal end portion of the terminal to be reduced. Accordingly, soldering of the connecting part to the connection land becomes easier.

(5) Preferably, the connecting part includes a bent part formed by bending the metal plate material and arranged at the distal end portion of the terminal in the extension direction of the terminal, and the bent part does not include the cut part arranged continuously with the surface of the connection land.

According to such a configuration, due to providing the bent part, the connecting part does not include a cut part continuous with the connection land, and thus soldering of the connection land and the connecting part is easy to perform.

(6) Preferably, the terminal includes a crimping part crimped to the wire.

According to such a configuration, the terminal and the wire can be connected, by crimping the crimping part to the wire.

(7) Preferably, the wiring module further includes a busbar to be connected

to electrode terminals of the plurality of power storage devices, and the busbar is connected to the wire.

According to such a configuration, the busbar and the circuit board can be electrically connected.

(8) Preferably, a core wire of the wire is made of an identical metal to the busbar.

According to such a configuration, the core wire of the wire is made of the same metal as the busbar, thus facilitating welding of the core wire and the busbar.

(9) Preferably, the circuit board includes a conduction path including the connection land, and the conduction path is formed only on one surface of the circuit board.

According to such a configuration, the conduction path is provided only on one surface of the circuit board, thus enabling the manufacturing costs of the wiring module to be reduced, compared to the case where conduction paths are provided on both surfaces of the circuit board.

(10) Preferably, a through hole passing through the circuit board is not formed in the connection land.

According to such a configuration, a through hole is not provided in the connection land, and thus soldering by laser irradiation is easy to perform.

(11) The above wiring module is a vehicle wiring module to be electrically attached to the plurality of power storage devices installed in a vehicle.

### Detailed Description of Embodiments of Disclosure

Hereinafter, embodiments of the present disclosure will be described. The present disclosure is not limited to these illustrative examples and is defined by the claims, and all changes that come within the meaning and range of equivalency of the claims are intended to be embraced therein.

### First Embodiment

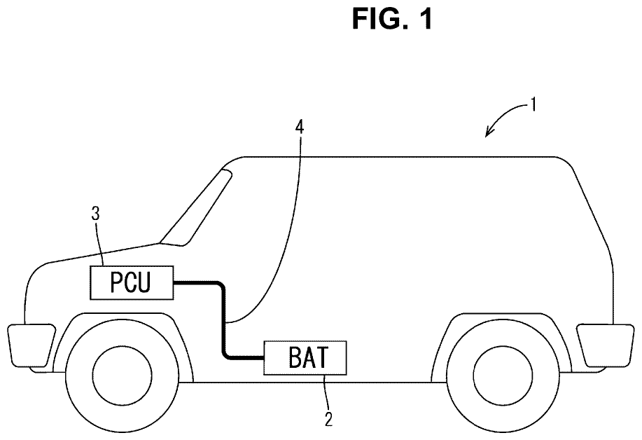

A first embodiment of the present disclosure will now be described with reference to FIGS. 1 to 10. A power storage module 10 provided with a wiring module 20 of the present embodiment is, for example, applied to a power storage pack 2 installed in a vehicle 1, as shown in FIG. 1. The power storage pack 2 is installed in the vehicle 1, which is an electric vehicle, a hybrid vehicle, or the like, and used as a drive source of the vehicle 1. In the following description, only some of a plurality of identical members may be denoted by reference numerals, and the reference numerals of the remaining members may be omitted.

As shown in FIG. 1, the power storage pack 2 is arranged near the center of the vehicle 1. A PCU 3 (Power Control Unit) is arranged in a front portion of the vehicle 1. The power storage pack 2 and the PCU 3 are connected by a wire harness 4. The power storage pack 2 and the wire harness 4 are connected by a connector not shown. The power storage pack 2 has the power storage module 10 provided with a plurality of power storage devices 11. The power storage module 10 (and the wiring module 20) can be installed in any orientation, and, hereinafter, except for FIG. 1, the direction indicated by an arrow Z is upward, the direction indicated by an arrow X is forward, and the direction indicated by an arrow Y is leftward.

### Power Storage Devices, Electrode Terminals

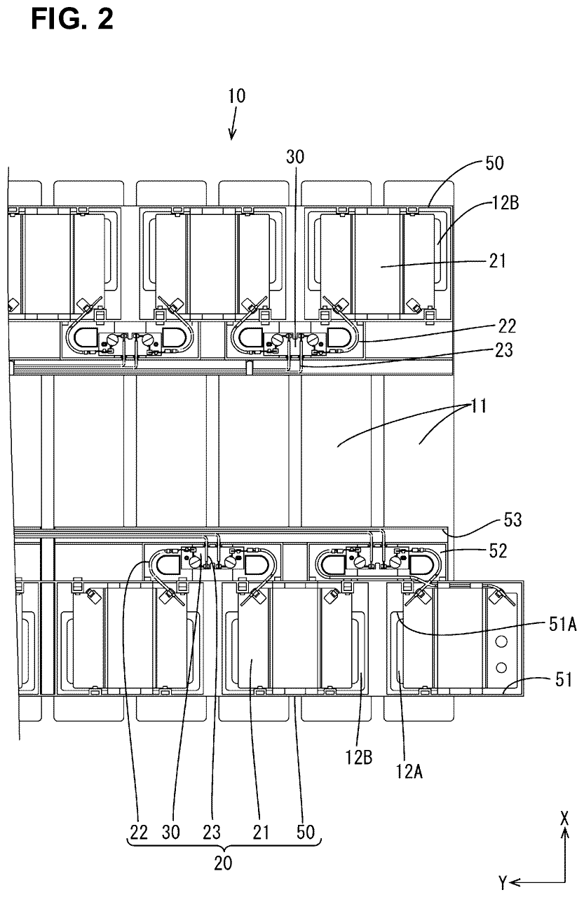

As shown in FIG. 2, the power storage module 10 includes the plurality of power storage devices 11 arranged in a row in a left-right direction, and the wiring module 20 mounted on upper surfaces of the plurality of power storage devices 11 (left side portion of the power storage module 10 is not shown). The power storage devices 11 have a flattened rectangular parallelepiped shape. Inside the power storage devices 11 are housed power storage elements not shown. The power storage devices 11 have positive and negative electrode terminals 12A and 12B on the upper surface thereof. The power storage devices 11 are not particularly limited, and may be secondary batteries or may be capacitors. The power storage devices 11 according to the present embodiment are secondary batteries.

### Wiring Module

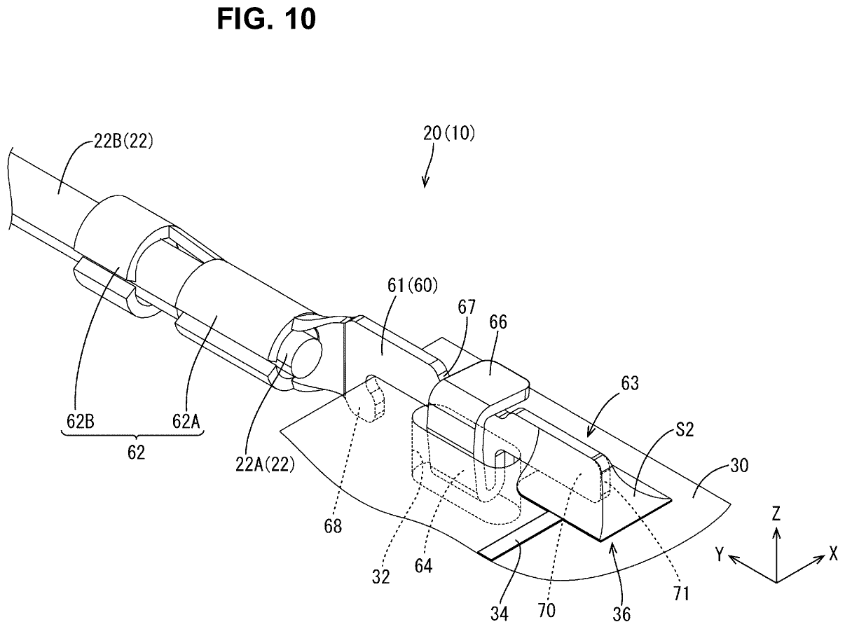

The wiring module 20 includes busbars 21 connected to the electrode terminals 12A and 12B, first wires 22 (example of wire) connected to the busbars 21, a circuit board 30, terminals 60 (see FIG. 10) connecting the first wires 22 to the circuit board 30, second wires 23 connected to the circuit board 30, and a protector 50 holding the busbars 21, the circuit board 30, and the second wires 23. As shown in FIG. 2, the wiring module 20 is configured to be attached to the front side and rear side of the plurality of power storage devices 11. Hereinafter, the configuration of the wiring module 20 arranged on the rear side will be described in detail. Note that the wiring module 20 arranged on the front side is inverted in both the front-back direction and the left-right direction, but otherwise there is no difference between the configuration of the wiring module 20 arranged on the front side and the configuration of the wiring module 20 arranged on the rear side.

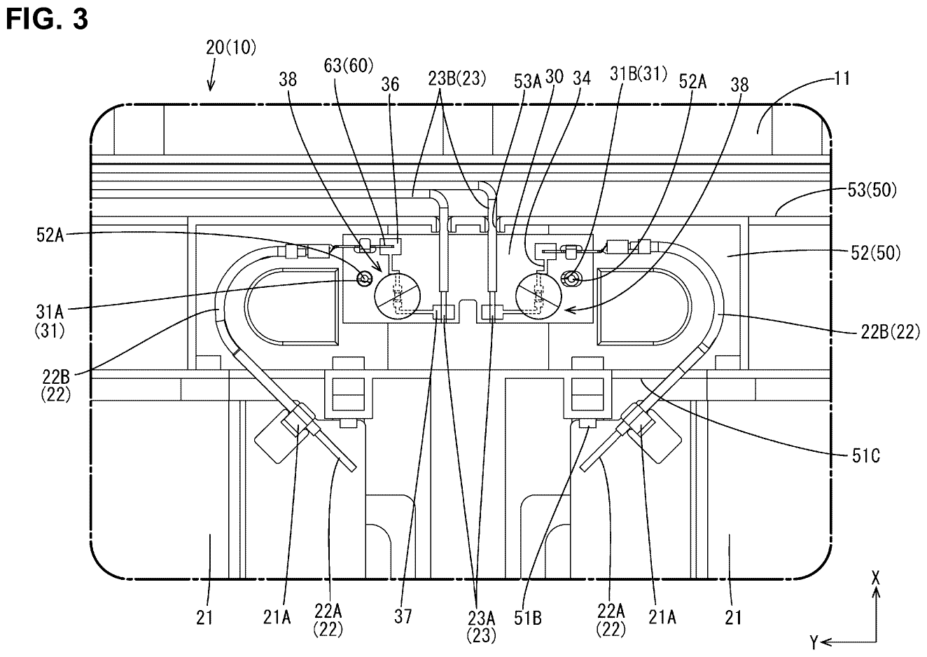

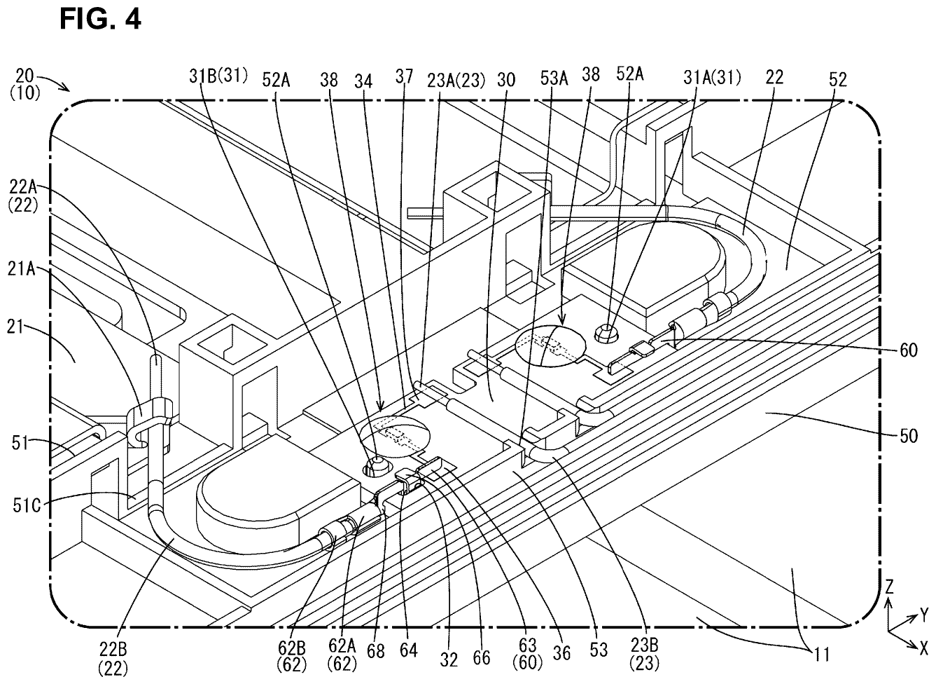

The protector 50 is made of an insulating synthetic resin and has a plate shape. The protector 50 includes a busbar housing part 51 in which the busbars 21 are housed, a board holding part 52 in which the circuit board 30 is held, and a wire routing part 53 on which the second wires 23 are routed. The busbar housing part 51 has a frame shape. Connection holes 51A for connecting the electrode terminals 12A and 12B to the busbars 21 are formed in a lower portion of the busbar housing part 51. As shown in FIG. 3, locking parts 51B for holding the busbars 21 within the busbar housing part 51 are provided on a peripheral wall of the busbar housing part 51. As shown in FIG. 4, a side wall of the busbar housing part 51 is provided with recessed parts 51C that are recessed downward in places. The first wires 22 are disposed within the recessed parts 51C.

As shown in FIG. 4, the wire routing part 53 has a groove shape extending in the left-right direction. The board holding part 52 is arranged between the busbar housing part 51 and the wire routing part 53. Wire insertion parts 53A are formed in a recessed shape in a groove wall on the board holding part 52 side of the wire routing part 53. The second wires 23 inserted into the wire insertion parts 53A are connected to the circuit board 30. The board holding part 52 includes protruding parts 52A that are inserted into insertion holes 31 in the circuit board 30. The protruding parts 52A have a cylindrical shape extending in the up-down direction.

### Busbars

The busbars 21 are made of a metal plate material having conductivity. Examples of the metal constituting the busbars 21 include copper, a copper alloy, aluminum, an aluminum alloy, and stainless steel (SUS). As shown in FIG. 2, the busbars 21 are rectangular in plan view. The busbars 21 and the electrode terminals 12A and 12B are electrically connected by welding. There are busbars 21 that connect the electrode terminals 12A and 12B of adjacent power storage devices 11, and busbars 21 that are connected to all the positive electrodes or all the negative electrodes of the plurality of power storage devices 11, but no particular distinction therebetween will be made below. As shown in FIG. 4, the busbars 21 each include a fastening part 21A that fastens the first wire 22. The fastening part 21A is formed by cutting and raising a vicinity of the side edge of the busbar 21. The busbar 21 and the first wire 22 are electrically connected by welding.

### First Wires

The first wires 22 each have a core wire 22A and an insulation coating 22B covering the core wire 22A. One end portion of the first wire 22 is connected to the busbar 21 by welding. In the present embodiment, the core wire 22A of the first wire 22 is made of the same type of metal as the busbar 21. The strength of the welded portion between the core wire 22A of the first wire 22 and the busbar 21 can thereby be improved.

The other end portion of the first wire 22 is electrically connected to a terminal 60 by being crimped by a crimping part 62 of the terminal 60. The terminal 60 is connected to the circuit board 30 by soldering. The first wire 22 has a shape that curves from the end portion thereof on the busbar 21 side to the end portion thereof on the circuit board 30 (terminal 60) side.

The first wires 22 electrically connecting the busbars 21 to the circuit board 30 are in a curved state. That is, the first wires 22 have residual length with respect to the linear distance between the busbars 21 and the circuit board 30. As a result of the first wires 22 deforming, the busbars 21 can be displaced to some extent in any of the direction in which the busbars 21 are arranged (left-right direction), the direction away from or closer to the circuit board 30 (front-back direction), and the thickness direction of the circuit board 30 (up-down direction). Thus, even if the temperature changes due to use of the vehicle 1 in which the power storage module 10 is installed and the power storage devices 11 (and busbars 21) expand or contract, or the busbars 21 deform due to an external force being applied to the wiring module 20, the connecting portions between the first wires 22 and the busbars 21 and the connecting portions between the first wires 22 and the circuit board 30 are unlikely to be damaged, making it easy to maintain the electrical connection between the busbars 21 and the circuit board 30 via the first wires 22.

### Terminals

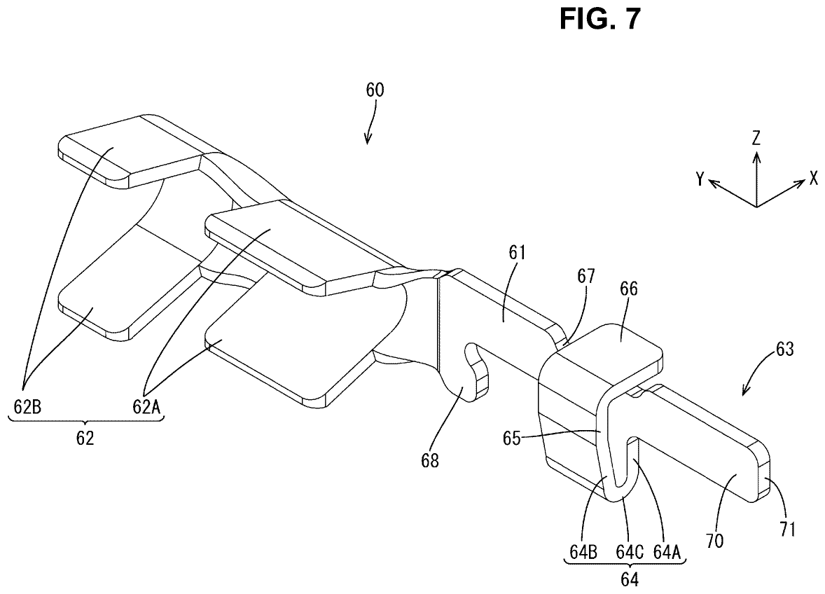

The terminals 60 are formed by processing a metal plate material having conductivity. Examples of the metal constituting the terminals 60 include copper, a copper alloy, aluminum, and an aluminum alloy. The terminals 60 of the present embodiment are made of a copper alloy. As shown in FIG. 10, the terminals 60 are each connected to a first land 36 (example of connection land) of the circuit board 30 by soldering. For example, if the metal constituting the core wire 22A of the first wires 22 has poor wettability of molten solder, it is difficult to directly connect the first wires 22 to the circuit board 30 by soldering. In the present embodiment, the terminals 60 are provided between the first wires 22 and the circuit board 30, thus enabling the first wires 22 to be electrically connected to the circuit board 30, even if it is difficult to directly solder the first wires 22 to the circuit board 30. As shown in FIG. 7, the terminals 60 each include a terminal body 61, the

crimping part 62 joined to the terminal body 61, a connecting part 63 arranged at the end portion of the terminal body 61 on the opposite side to the crimping part 62, and a press-fit part 64 extending downward from the terminal body 61. Note that, in FIG. 7, the front-back direction, the left-right direction, and the up-down direction are defined based on the posture of the terminal 60 arranged on the left side of FIG.

3. The terminal body 61 is long in the left-right direction and flattened in the front-back direction. As shown in FIG. 4, the crimping part 62 includes a wire barrel 62A that is crimped to the core wire 22A of the first wire 22 and an insulation barrel 62B that is crimped to the insulation coating 22B of the first wire 22.

### Connecting Part, Pair of Connecting Surfaces, Cut Part

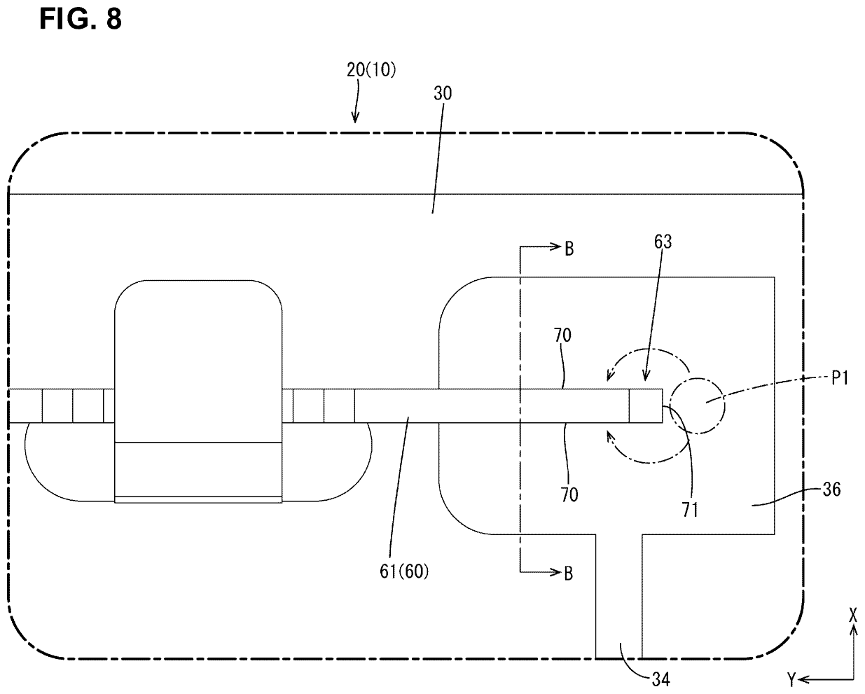

The connecting part 63 has a flattened plate shape. As shown in FIG. 8, the connecting part 63 has a pair of connecting surfaces 70 that are positioned front and back of each other, and a cut part 71 that connects the pair of connecting surfaces 70. The connecting surfaces 70 are arranged on the front and rear surfaces of the connecting part 63. The pair of connecting surfaces 70 are the outer surfaces of the metal plate material from which the terminal 60 originates. As shown in FIG. 7, the cut part 71 connects outer edge portions of the pair of connecting surfaces 70. The cut part 71 is a portion formed by cutting the metal plate material from which the terminal 60 originates. The cut part 71 is thus more difficult to wet with solder than the connecting surfaces 70.

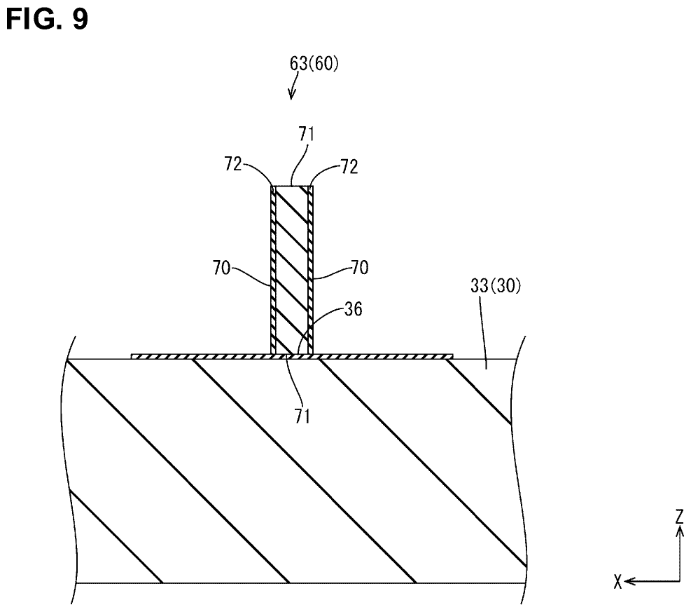

In the present embodiment, as shown in FIG. 9, the connecting part 63 is arranged on the first land 36 of the circuit board 30, with the connecting surfaces 70 intersecting the surface of the circuit board 30 substantially perpendicularly and joined thereto. Also, the cut part 71 arranged on the lower side of the connecting part 63 is arranged opposing the surface of the first land 36 of the circuit board 30 in the up-down direction. Both of the pair of connecting surfaces 70 thereby intersect the surface of the first land 36 substantially perpendicularly and are arranged continuously therewith.

### Soldering of Terminal and Circuit Board

Hereinafter, an example of soldering the terminal 60 and the circuit board 30 in the present embodiment will be described.

As shown in FIG. 8, after disposing the connecting part 63 on the first land 36, a soldering iron is disposed in a heating region P1 of the first land 36 located on the front side of the connecting part 63 or the heating region P1 is irradiated with a laser beam. Thread solder is fed to the heating region P1 heated by the soldering iron or the laser beam, and the solder is melted on the first land 36. Following heat dissipation from the first land 36 to the connecting part 63, the molten solder wets and spreads toward the connecting part 63 from the first land 36, as shown by the arrow of the one-dot chain line in FIG. 8. In the present embodiment, as shown in FIG. 9, the connecting surfaces 70 having superior solder wettability are arranged continuously with the surface of the first land 36, and thus the molten solder tends to wet and spread to the connecting surfaces 70. Accordingly, the first land 36 and the connecting part 63 can be smoothly connected by solder S2 (see FIG. 10).

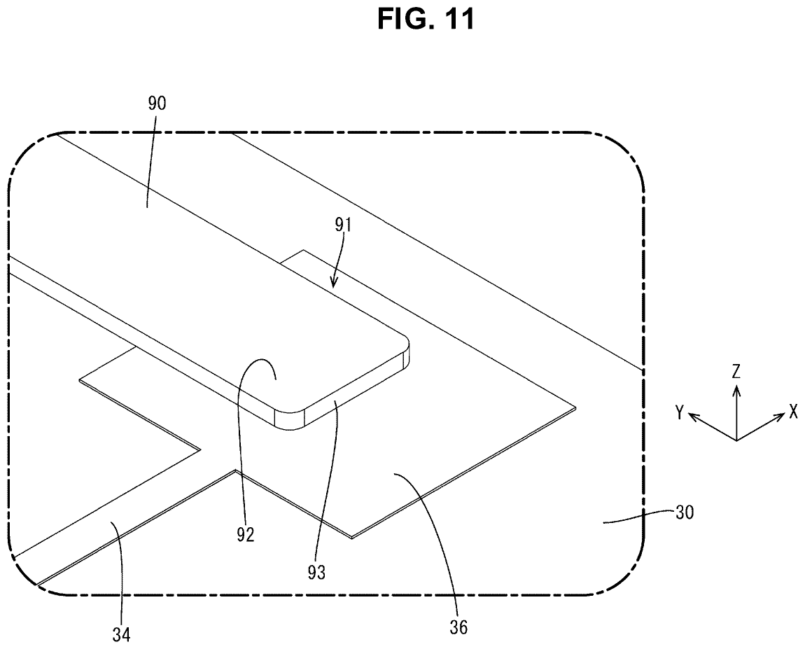

On the other hand, a terminal 90 (comparative example) different from the present embodiment, in which a connecting part 91 is arranged on the first land 36 with a connecting surface 92 substantially parallel to the surface of the first land 36, as shown in FIG. 11, will be considered. With such a configuration, the connecting surface 92 which is easy to wet with solder is not arranged continuously with the first land 36, and a cut part 93 that is difficult to wet with solder is arranged continuously with the first land 36. Accordingly, compared to the present embodiment, it can be difficult to solder the first land 36 and the connecting part 91 using a soldering iron or the like. For example, in order for the connecting surface 92 on the upper surface of the connecting part 91 which is easy to wet with solder to be connected to the first land 36 with solder, a large amount of solder may need to be melted on the first land 36.

### Plating Layer

In the present embodiment, as shown in FIG. 9, a plating layer 72 is formed on the surface of the terminal 60. As the metal constituting the plating layer 72, tin, nickel or the like having superior solder wettability is used. The plating layer 72 of the present embodiment is made of tin. The plating layer 72 is usually formed on the outer surface of the metal plate material from which the terminal 60 originates. The plating layer 72 is thus formed on the pair of connecting surfaces 70 in the connecting part 63. On the other hand, the plating layer 72 is not formed on the cut part 71. The metal (copper alloy in the present embodiment) of the metal plate material mainly constituting the terminal 60 is exposed at the cut part 71. Therefore, in the terminal 60 on which the plating layer 72 is formed, the connecting surfaces 70, in particular, have superior solder wettability to the cut part 71. In the present embodiment, the connecting surfaces 70 are arranged continuously with the first land 36, and thus the plating layer 72 and the first land 36 are arranged continuously. Accordingly, soldering of the connecting part 63 and the first land 36 is facilitated.

As shown in FIG. 7, the terminal 60 is provided with a press-fit part 64 between the connecting part 63 and the crimping part 62. The press-fit part 64 extends downward from the terminal body 61 and then bends upward. The press-fit part 64 includes a base part 64A extending downward from the terminal body 61, an opposing plate part 64B opposing the base part 64A in the front-back direction, and a bent part 64C connecting the base part 64A and the opposing plate part 64B. The press-fit part 64 has a leaf spring shape. The opposing plate part 64B inclines so as to be located further away from the base part 64A in the front-back direction proceeding upward. As shown in FIG. 10, the press-fit part 64 is configured to be press-fit into a press-fit hole 32 in the circuit board 30.

As shown in FIG. 7, the terminal 60 includes an extending part 65 extending upward from an upper end portion of the opposing plate part 64B of the press-fit part 64 and a pressing part 66 extending forward from an upper end portion of the extending part 65. The terminal 60 includes a press-receiving part 67 that is recessed downward from the upper surface of the terminal body 61. The pressing part 66 is configured to be arranged inside the press-receiving part 67. The press-fit part 64 is easily press-fit into the press-fit hole 32, by pressing the pressing part 66 (see FIG. 10).

As shown in FIG. 7, the terminal 60 includes a positioning raised part 68 on the crimping part 62 side of the terminal body 61. The positioning raised part 68 extends downward from the terminal body 61 and further extends so as to approach the press-fit part 64. The positioning raised part 68 opposes the press-fit part 64 in the left-right direction. After press-fitting the press-fit part 64 into the press-fit hole 32, the terminal 60 can be positioned with respect to the circuit board 30, by bringing the positioning raised part 68 into contact with the end face of the circuit board 30 (see FIG. 10). More specifically, positioning of the connecting part 63 and the first land 36 can be performed.

As shown in FIG. 4, the second wires 23 each have a core wire 23A and an insulation coating 23B covering the core wire 23A. The core wire 23A exposed at one end of the second wire 23 is connected to a second land 37 by soldering. The insulation coating 23B at the one end of the second wire 23 is inserted into the wire insertion part 53A and fixed. Although not shown, the other end of the second wire 23 is connected to an external ECU (Electronic Control Unit) or the like via a connector. The ECU is equipped with a microcomputer, devices, and the like, and has a well-known configuration provided with functions such as detecting the voltage, current, temperature, and the like of each power storage device 11 and controlling charging and discharging of each power storage device 11.

### Circuit Board

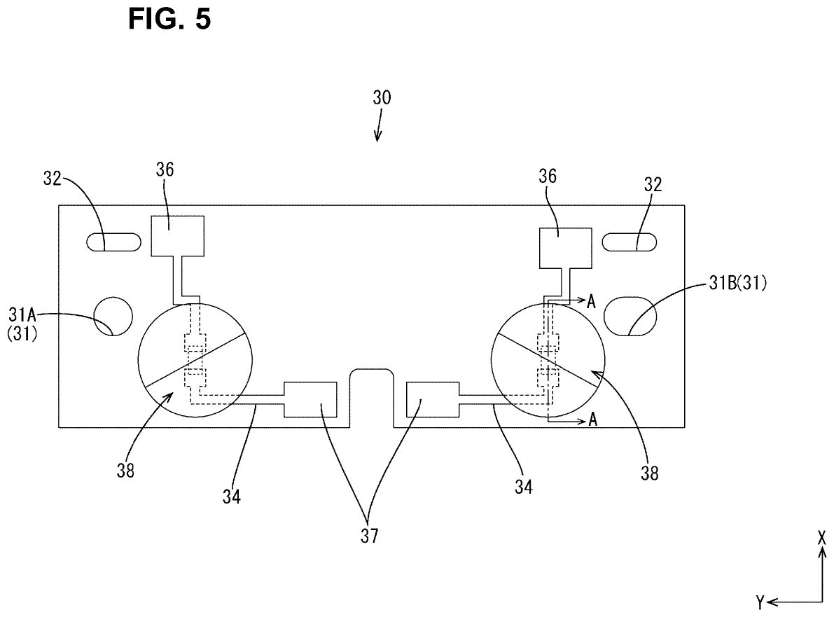

The circuit board 30 of the present embodiment is a rigid board that does not have flexibility. As shown in FIG. 5, the circuit board 30 has a long rectangular shape in the left-right direction in plan view. The circuit board 30 has insertion holes 31 and press-fit holes 32 that pass through the circuit board 30 in the up-down direction formed therein. The insertion holes 31 are provided one in the left end portion and one in the right end portion of the circuit board 30. One of the insertion holes 31 is a first insertion hole 31A having a substantially circular shape in plan view. The other insertion hole 31 is a second insertion hole 31B having a long hole shape extending in the left-right direction in plan view. The press-fit holes 32 are provided one in the left end portion and one in the right end portion of the circuit board 30. The press-fit holes 32 are arranged at positions adjacent to the first lands 36 in the left-right direction. The press-fit holes 32 have a long hole shape that is long in the left-right direction in plan view.

As shown in FIG. 3, as a result of the protruding parts 52A of the protector 50 being inserted into the insertion holes 31, left-right and front-back movement of the circuit board 30 relative to the protector 50 is restricted. The second insertion hole 31B is a long hole, and thus has an internal shape that is large in the left-right direction with respect to the protruding part 52A which is cylindrical. Manufacturing tolerance of the insertion holes 31 and the protruding parts 52A in the left right direction can thereby be absorbed.

As shown in FIG. 4, the press-fit parts 64 of the terminals 60 are press-fit into the press-fit holes 32. A hole diameter of each press-fit hole 32 in the left-right direction is set larger than a dimension of the press-fit part 64 in the left-right direction. The hole diameter of the press-fit hole 32 in the front-back direction is set slightly smaller than the dimension of the press-fit part 64 in the front-back direction in a natural state. Therefore, the press-fit part 64 arranged inside the press-fit hole 32 will be in an elastically deformed state in contact with an inner wall of the press-fit hole 32. The press-fit part 64 can thereby be retained within the press-fit hole 32, and the terminal 60 can be fixed with respect to the circuit board 30. By fixing the terminal 60 to the circuit board 30, soldering of the connecting part 63 of the terminal 60 to the circuit board 30 becomes easier to perform.

Also, the press-fit part 64 is arranged between the crimping part 62 and the connecting part 63, and thus, even if stress is applied to the first wire 22, this stress is born by the press-fit part 64 and the inner wall of the press-fit hole 32, thus enabling application of stress to the connecting portion between the connecting part 63 and the circuit board 30 to be suppressed.

### Conduction Path

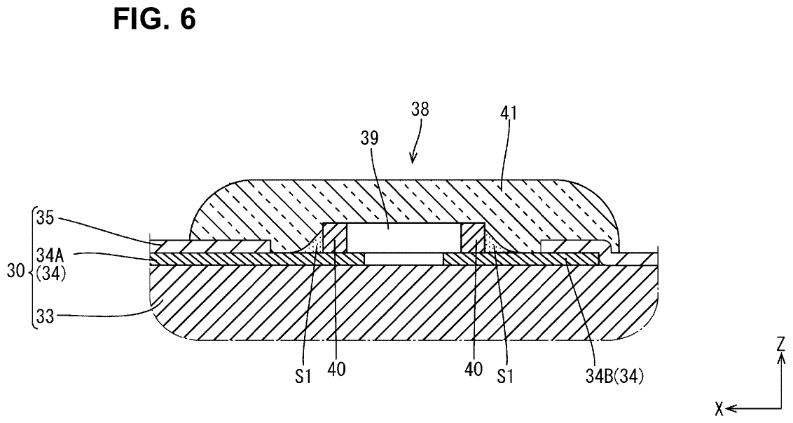

As shown in FIG. 6, the circuit board 30 includes an insulation plate 33 having insulating properties and a conduction path 34 routed on one surface (upper surface) of this insulation plate 33. The insulation plate 33 is formed by, for example, an epoxy resin being impregnated into a fiberglass cloth and cured. The conduction path 34 is made of a metal such as copper or a copper alloy, for example, and has conductivity. The conduction path 34 is covered with an insulation layer 35, except for the portions soldered to other members. The insulation layer 35 is constituted by a solder resist or the like. As shown in FIG. 5, the conduction path 34 includes the first land 36 arranged at one end of the conduction path 34, the second land 37 arranged at the other end of the conduction path 34, and a fuse part 38 provided between the first land 36 and the second land 37.

### First Lands

The first lands 36 are arranged one on the right side and one on the left side of the circuit board 30. Two second lands 37 are arranged toward the left-right center of the circuit board 30. As shown in FIG. 3, the first land 36 is soldered to the connecting part 63 of the terminal 60. The first land 36 is electrically connected to the busbar 21 via the terminal 60 and the first wire 22. The second land 37 is connected to the core wire 23A of the second wire 23 by soldering.

In the present embodiment, a through hole passing through the circuit board 30 is not formed in the first land 36. In other words, the first land 36 is not a so-called through-hole soldered portion. In the case where, unlike the present embodiment, a through hole is provided in the first land 36, the inner wall of the through hole can be overheated by the laser beam when soldering by laser irradiation is performed and the circuit board 30 can be damaged. In the present embodiment, a through hole is not provided in the first land 36, and thus soldering by laser irradiation is easy to perform.

As shown in FIG. 5, the fuse part 38 is provided on a portion of the conduction path 34 partway between the first land 36 and the second land 37. As shown in FIG. 6, the fuse part 38 of the present embodiment has a chip fuse 39, and the chip fuse 39 is connected to the conduction path 34 by solder S1. Specifically, one of a pair of electrodes 40 of the chip fuse 39 is connected to a conduction path 34A on the first land 36 side, and the other of the pair is connected to a conduction path 34B on the second land 37 side.

As a result of the fuse parts 38 being provided, even when the conduction paths 34 are short-circuited and overcurrent occurs due to a fault in an external circuit to which the power storage module 10 is connected, flow of the overcurrent through the conduction paths 34 from the power storage devices 11 can be restricted, by the chip fuses 39 melting.

As shown in FIG. 6, in the present embodiment, a connecting portion between the chip fuse 39 and the conduction path 34 is covered by a sealing part 41. Here, the connecting portion between the chip fuse 39 and the conduction path 34 includes at least the entirety of the chip fuse 39, the solder S1, and end portions of the conduction path 34 connected to the electrodes 40 of the chip fuse 39, which are portions not covered by the insulation layer 35. The sealing part 41 is made of a curable insulating resin. Since the sealing part 41 covers the connecting portion between the chip fuse 39 and the conduction path 34, short-circuiting of the conduction path 34 can be suppressed, even when water droplets or the like form on the circuit board 30 due to condensation.

### Method for Manufacturing Wiring Module

The configuration of the wiring module 20 is as described above, and, hereinafter, one example of a method for manufacturing the wiring module 20 will be described.

First, the crimping parts 62 of the terminals 60 are crimped onto the first wires 22. The end portions of these first wires 22 on the opposite side to the terminals 60 are fastened and fixed by the fastening parts 21A of the busbars 21, and the core wires 22A of the first wires 22 are welded to the busbars 21.

The circuit board 30 is manufactured using a printed wiring technology. The chip fuses 39 are soldered to the circuit board 30. The sealing parts 41 that seal the chip fuses 39 are formed. A liquid insulating resin before curing is dripped onto the connecting portions between the chip fuses 39 and the conduction paths 34 on the circuit board 30 using a dispenser or the like and applied in a dome shape. The applied insulating resin is cured by a known technique. Any technique can be appropriately selected as the technique for curing the insulating resin, such as cooling, mixing with a curing agent, or light irradiation.

The press-fit parts 64 of the terminals 60 are press-fit into the press-fit holes 32 in the circuit board 30 while pressing down on the pressing parts 66 of the terminals 60. The terminals 60 are fixed with respect to the circuit board 30, as a result of the press-fit parts 64 being arranged inside the press-fit holes 32. The terminals 60 are positioned with respect to the circuit board 30, by bringing the positioning raised parts 68 into contact with the end face of the circuit board 30. The connecting parts 63 of the terminals 60 are connected to the first lands 36 of the circuit board 30 by soldering. In the present embodiment, since the connecting surfaces 70 having comparatively superior solder wettability are arranged continuously with the first lands 36, soldering of the connecting parts 63 and the first lands 36 is facilitated.

The integrated busbars 21, circuit board 30, and first wires 22 are assembled to the protector 50. The busbars 21 are housed in the busbar housing part 51 of the protector 50. The busbars 21 are held within the busbar housing part 51 by the locking parts 51B. The circuit board 30 is disposed in the board holding part 52 of the protector 50. The protruding parts 52A are inserted into the insertion holes 31. The second wires 23 are routed in the wire routing part 53, and the end

portions of the second wires 23 where the core wires 23A are exposed are inserted within the wire insertion parts 53A. The core wires 23A of the second wires 23 are connected to the second lands 37 by soldering. Manufacturing of the wiring module 20 is thereby completed.

Note that the above is an example of the method for manufacturing the wiring module 20, and the order of the steps may be changed. For example, the second wires 23 may be soldered in the step of soldering the chip fuses 39 and the like to the circuit board 30. Also, welding of the busbars 21 to the first wires 22 may be performed after the busbars 21 are welded to the electrode terminals 12A and 12B.

### Operation and Effect of First Embodiment

The first embodiment achieves the following operation and effect.

The wiring module 20 of the first embodiment is a wiring module 20 to be attached to a plurality of power storage devices 11, including a wire (first wire 22), a terminal 60 connected to the wire, and a circuit board 30, with the terminal 60 including a connecting part 63 connected to the circuit board 30, the circuit board 30 including a connection land (first land 36) to which the connecting part 63 is soldered, and the connecting part 63 having a cut part 71 formed by cutting a metal plate material and a pair of connecting surfaces 70 arranged so as to be positioned front and back of each other and connected via the cut part 71, and at least one of the pair of connecting surfaces 70 intersecting the surface of the connection land and being arranged continuously therewith.

The terminal 60 is formed by punching, bending, or the like of a metal plate material. At this time, the connecting part 63 includes the cut part 71 formed by punching and the connecting surfaces 70 which are the outer surfaces of the original metal plate material. Generally, the cut part 71 has high surface tension because of the surface roughness being large compared to the connecting surfaces 70. Accordingly, the cut part 71 has poorer solder wettability than the connecting surfaces 70.

According to the above configuration, the connection land is arranged continuously with the connecting surfaces 70 of the connecting part 63, and thus soldering of the connection land and the connecting part 63 is easy to perform, as a result of the solder wetting and spreading from the connection land to the connecting surfaces 70.

In the first embodiment, the surface of the connection land opposes part of the cut part 71, and both of the pair of connecting surfaces 70 are arranged continuously with the surface of the connection land.

According to such a configuration, both of the pair of connecting surfaces 70 are continuous with the surface of the connection land, and thus soldering of the connection land and the connecting part 63 becomes easier to perform.

In the first embodiment, the connecting part 63 includes a plating layer 72, and the surface of the plating layer 72 constitutes at least part of the pair of connecting surfaces 70.

According to such a configuration, by using a metal whose solder wettability is superior to the metal constituting the inside of the terminal 60 as the plating layer 72, soldering of the connection land and the connecting part 63 becomes easier to perform.

In the first embodiment, the terminal 60 includes a crimping part 62 crimped to the wire.

According to such a configuration, the terminal 60 and the wire can be connected, by crimping the crimping part 62 to the wire.

The wiring module 20 of the first embodiment further includes a busbar 21 to be connected to electrode terminals 12A and 12B of the plurality of power storage devices 11, and the busbar 21 is connected to the wire.

According to such a configuration, the busbar 21 and the circuit board 30 can be electrically connected.

In the first embodiment, the core wire 22A of the wire is made of the same metal as the busbar 21.

According to such a configuration, the core wire 22A of the wire is made of the same metal as the busbar 21, thus allowing welding of the core wire 22A and the busbar 21 to be facilitated.

In the first embodiment, the circuit board 30 includes a conduction path 34 including the connection land, and the conduction path 34 is formed only on one surface of the circuit board 30.

According to such a configuration, the conduction path 34 is provided only on one surface of the circuit board 30, thus enabling the manufacturing costs of the wiring module 20 to be reduced, compared to the case where the conduction path 34 is provided on both surfaces of the circuit board 30.

In the first embodiment, a through hole that passes through the circuit board 30 is not formed in the connection land.

According to such a configuration, a through hole is not provided in the connection land, and thus soldering by laser irradiation is easy to perform.

The wiring module 20 according to the first embodiment is a vehicle wiring module 20 to be electrically attached to the plurality of power storage devices 11 installed in a vehicle 1.

### Second Embodiment

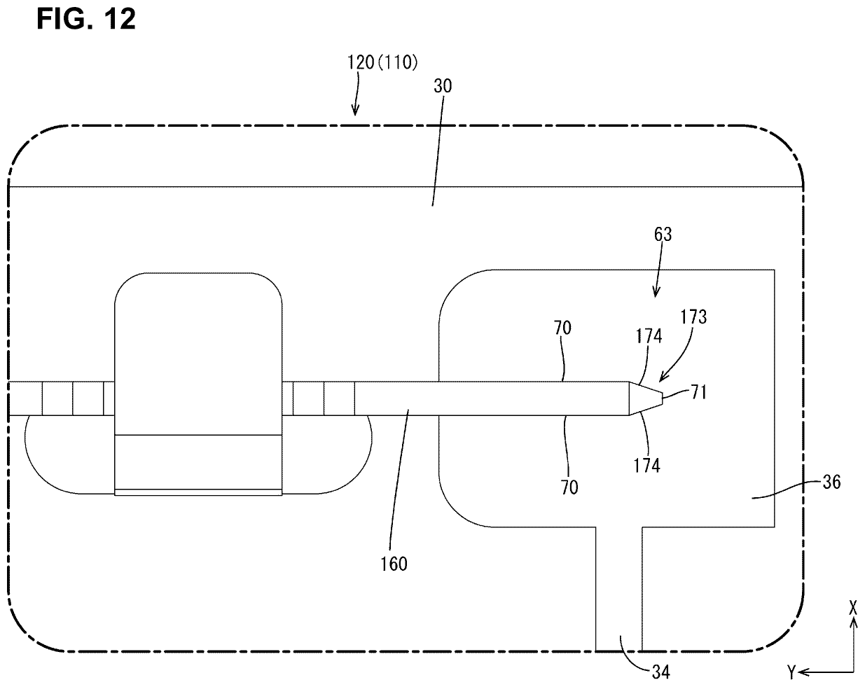

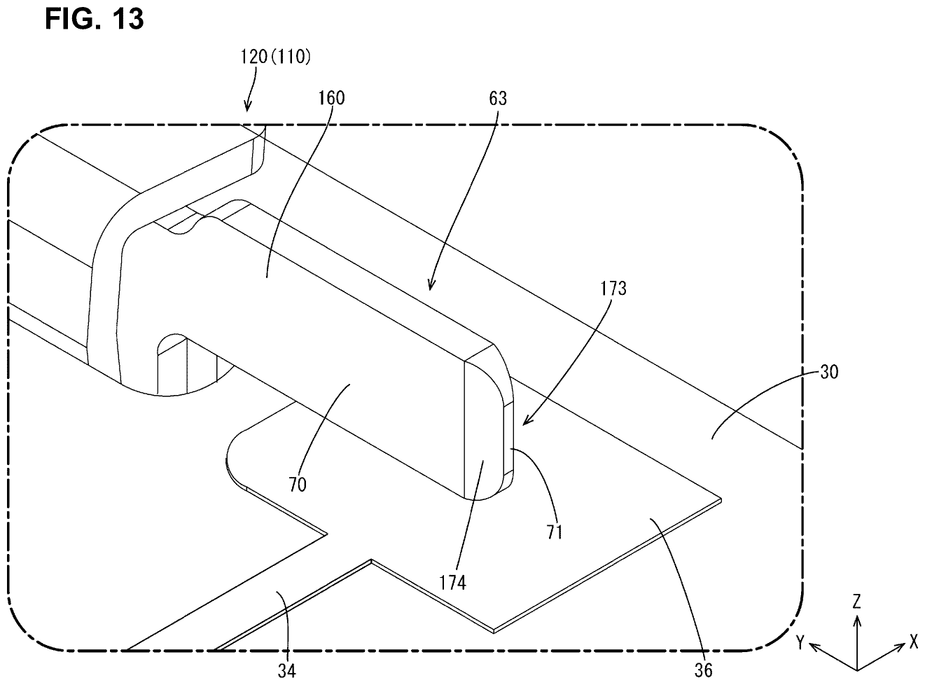

A second embodiment of the present disclosure will now be described with reference to FIGS. 12 and 13. The configuration of the second embodiment is identical to the configuration of the first embodiment, except for inclusion of a terminal 160. Hereinafter, members that are identical to the first embodiment will be given reference numerals used in the first embodiment, and description of configuration and operation and effect that are identical to the first embodiment will be omitted.

### Tapered Part

A wiring module 120 (power storage module 110) according to the second embodiment includes the terminal 160. The terminal 160 is configured similarly to the terminal 60 of the first embodiment, except for provision of a tapered part 173 on the distal end portion of the terminal 160 (right end portion in FIGS. 12 and 13). The tapered part 173 has an inclined surface 174 in which the pair of connecting surfaces 70 incline so as to approach each other proceeding toward the distal end portion side of the terminal 160 in the extension direction (left-right direction) of the terminal 160. As a result, as shown in FIG. 13, the area of the cut part 71 connected to the inclined surface 174 decreases. In particular, the area of the cut part 71 constituting the distal end portion of the connecting part 63 arranged continuously with the first land 36 decreases. Accordingly, soldering of the connecting part 63 and the first land 36 is facilitated.

### Operation and Effect of Second Embodiment

According to the second embodiment, the following operation and effect are achieved.

In the second embodiment, the connecting part 63 is provided with the tapered part 173 that includes the distal end portion of the terminal 160 in the extension direction (left-right direction) of the terminal 160, and the tapered part 173 has a tapered shape due to the pair of connecting surfaces 70 inclining so as to approach each other proceeding toward the distal end portion side in the extension direction.

According to such a configuration, the connecting part 63 is provided with the tapered part 173 that includes the distal end portion of the terminal 160, thus enabling the area of the cut part 71 arranged at the distal end portion of the terminal 160 to be reduced. Accordingly, soldering of the connecting part 63 to the connection land (first land 36) becomes easier to perform.

### Third Embodiment

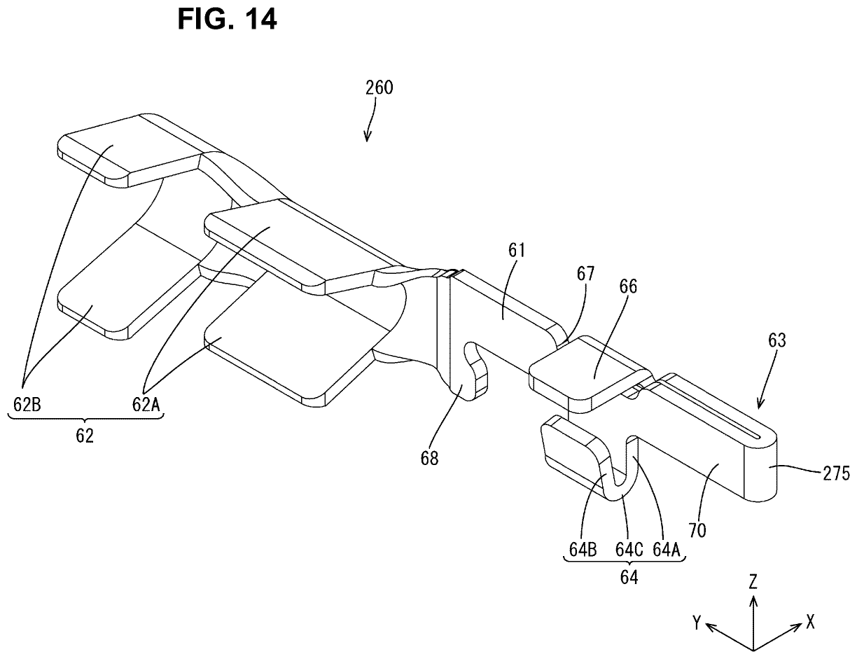

A third embodiment of the present disclosure will now be described with reference to FIG. 14. The configuration of the third embodiment is identical to the first embodiment, except for inclusion of a terminal 260. Hereinafter, members that are identical to the first embodiment will be given reference numerals used in the first embodiment, and description of configuration and operation and effect that are identical to the first embodiment will be omitted.

### Bent Part

The terminal 260 according to the third embodiment has a bent part 275 in which a metal plate material is bent 180 degrees on the distal end portion side of the terminal 260. Note that the distal end portion of the terminal 260 is the end portion (right end portion in FIG. 14) on the opposite side to the crimping part 62 in the extension direction (left-right direction) of the terminal 260. In the first embodiment, as shown in FIG. 10, the cut part 71 is arranged continuously with the first land 36 at the distal end portion of the terminal 60, whereas, in the third embodiment, the bent part 275 is provided at the distal end portion of the terminal 260, and thus the cut part 71 is not arranged continuously with the first land 36. Accordingly, soldering of the connecting part 63 and the first land 36 is facilitated.

### Operation and Effect of Third Embodiment

The third embodiment achieves the following operation and effect.

In the third embodiment, the connecting part 63 includes the bent part 275 formed by bending a metal plate material and arranged at the distal end portion of the terminal 260 in the extension direction of the terminal 260, and the bent part 275 does not include the cut part 71 arranged continuously with the surface of the connection land (first land 36).

According to such a configuration, by providing the bent part 275, soldering of the connection land and the connecting part 63 is easy to perform, since the connecting part 63 does not include the cut part 71 continuous with the connection land.

### Other Embodiments

(1) In the above embodiments, one circuit board 30 includes two first lands 36, but the present disclosure is not limited thereto, and one circuit board may include one connection land or three or more connection lands.
(2) In the above embodiments, the terminals 60, 160, and 260 include the press-fit part 64, but the present disclosure is not limited thereto, and the terminal need not be provided with a press-fit part.
(3) In the above embodiments, a rigid board is used as the circuit board 30, but the present disclosure is not limited thereto, and the circuit board may be a flexible board such as a flexible printed circuit board or a flexible flat cable.
(4) In the above embodiments, the wiring modules 20 and 120 are provided with the protector 50, but the present disclosure is not limited thereto, and the wiring module need not be provided with a protector.

### LIST OF REFERENCE NUMERALS

1 Vehicle
2 Power storage pack
3 PCU
4 Wire harness
10, 110 Power storage module
11 Power storage device
12A, 12B Electrode terminal
20, 120 Wiring module
21 Busbar
21A Fastening part
22 First wire
22A Core wire
22B Insulation coating
23 Second wire
23A Core wire
23B Insulation coating
30 Circuit board
31 Insertion hole
31A First insertion hole
31B Second insertion hole
32 Press-fit hole
33 Insulating board
34, 234 Conduction path
34A Conduction path on first land side
34B Conduction path on second land side
35 Insulation layer
36 First land
37 Second land
38, 238 Fuse part
39 Chip fuse
40 Electrode
41 Sealing part
50 Protector
51 Busbar housing part
51A Connection hole
51B Locking part
51C Recessed part
52 Board holding part
52A Protruding part
53 Wire routing part
53A Wire insertion part
60, 160, 260 Terminal
61 Terminal body
62 Crimping part
62A Wire barrel
62B Insulation barrel
63 Connecting part
64 Press-fit part
64A Base part
64B Opposing plate part
64C Bent part
65 Extending part
66 Pressing part
67 Press-receiving part
68 Positioning raised part
70 Connecting surface
71 Cut part
72 Plating layer
90 Terminal according to comparative example
91 Connecting part
92 Connecting surface
93 Cut part
173 Tapered part
174 Inclined surface
275 Bent part
P1 Heating region
S1, S2 Solder

1. A wiring module to be attached to a plurality of power storage devices, comprising:
a wire;
a terminal connected to the wire; and
a circuit board,
wherein the terminal includes a connecting part connected to the circuit board,
the circuit board includes a connection land to which the connecting part is soldered,
the connecting part has a cut part formed by cutting a metal plate material, and a pair of connecting surfaces arranged so as to be positioned front and back of each other and connected via the cut part, and
at least one of the pair of connecting surfaces intersects a surface of the connection land and is arranged continuously therewith.

2. The wiring module according to claim 1,
wherein the connecting part includes a plating layer, and
a surface of the plating layer constitutes at least part of the pair of connecting surfaces.

3. The wiring module according to claim 1,
wherein the surface of the connection land opposes part of the cut part, and
both of the pair of connecting surfaces are arranged continuously with the surface of the connection land.

4. The wiring module according to claim 1,
wherein the connecting part has a tapered part including a distal end portion of the terminal in an extension direction of the terminal, and
the tapered part has a tapered shape formed by the pair of connecting surfaces approaching each other proceeding toward the distal end portion side in the extension direction.

5. The wiring module according to claim 1,
wherein the connecting part includes a bent part formed by bending the metal plate material and arranged at a the distal end portion of the terminal in an the extension direction of the terminal, and
the bent part does not include the cut part arranged continuously with the surface of the connection land.

6. The wiring module according to claim 1,
wherein the terminal includes a crimping part crimped to the wire.

7. The wiring module according to claim 1, further comprising a busbar to be connected to electrode terminals of the plurality of power storage devices,
wherein the busbar is connected to the wire.

8. The wiring module according to claim 7,
wherein a core wire of the wire is made of an identical metal to the busbar.

9. The wiring module according to claim 1,
wherein the circuit board includes a conduction path including the connection land, and
the conduction path is formed only on one surface of the circuit board.

10. The wiring module according to claim 1,
wherein a through hole passing through the circuit board is not formed in the connection land.

11. The wiring module according to claim 1 is a vehicle wiring module to be electrically attached to the plurality of power storage devices installed in a vehicle.
